(19) United States
(12) Patent Application Publication
(10) Pub. No.: US 2017/0017911 A1
(43) Pub. Date: Jan. 19, 2017

(54) METHOD AND SYSTEM FOR EFFICIENT EVENT MANAGEMENT

(71) Applicant: Robert Thomas Boyer, Longmont, CO (US)

(72) Inventor: Robert Thomas Boyer, Longmont, CO (US)

(21) Appl. No.: 14/800,884

(22) Filed: Jul. 16, 2015

(51) Int. Cl. G06Q 10/06

(52) U.S. Cl. CPC G06Q 10/06313

(57) ABSTRACT

An event coordination system for coordinating a competitive event is provided. The event coordination system includes a storage system storing an event coordination routine, event participant information, event areas information, competition information, and an event schedule, and a processing system coupled to the storage system, wherein the processing system when executing the event coordination routine is configured to retrieve the event participant information for a plurality of event participants, retrieve the event areas information and the competition information, and process the event participant information with the event areas information and the competition information and generate the event schedule for coordinating the competitive event. The event schedule coordinates the plurality of event participants over a plurality of event areas.

### TECHNICAL FIELD

The disclosure relates generally to a method and a system for providing effective situational awareness, efficient communications, and event management of individual competitors and competition brackets for large sporting events, and more particularly, to techniques for facilitating and eliminating idle time at competition rings at large martial arts events.

### BACKGROUND

Sporting events are composed of many individual competitors, who are then gathered into different ages (e.g., 6-7 year olds), genders, skills (e.g., yellow belt), and weights (e.g., welter weight). Groups called brackets (aka divisions) are inherently difficult to manage. The quantity of such brackets can easily exceed 600, even for local tournaments. The common method for event organizers to judge the success of such tournaments is how long it takes to run the event. Did the competition last until after midnight or did it finish by 10:00 PM? The key is effective use of available rings, because every event, e.g., presentation or competition, takes place in a ring. The coaches, competitors, and spectators also judge how the event by how smooth it flows, that they know where to go, can get to where they need to be, and can see what they want to see. In short, a competition is judged on how well the information flow is communicated to all participants

At a typical tournament, individual competitors relax, stretch, and warm-up as they feel inclined, until such time as the holding manager calls forth their bracket. These competitors are then assembled and then often forced to wait in the holding area until they are sent out to a given ring. Due to a lack of knowledge as to when a bracket may be called up, all competitors are typically required to remain on standby, in a holding area, so as to not miss being present for their event. Due to a lack of knowledge as to when the next ring will become available, once called, the competitors frequently are made to endure long waits (e.g., multiple hours). The competitors, e.g., 6-7 and 8-9 year olds may be held in isolation, with access denied to their parents.

There are three common methods for keeping the rings as active as possible at such large events. The first, and by far the most popular, is the ad-hoc method. Although a general ordering of brackets (e.g., presentation events first, then sparring; and youngest competitors first to oldest) may be known, when and where a bracket will be deployed is dependent on the flow of activities, which rings are manned by which referees, (who are certified to judge only certain events), or other additional factors. Brackets are sent to rings as the rings become available. Due to lack of any coordinated system, the time when the next ring will be available is unknown.

Other than the mumbled voice over a public announcement system, there is extremely poor communications as to where competitors and spectators are supposed to be and when they need to be there. Often when a ring does become available, the group of competitors are sent out without notification to the spectators, e.g., parents, as to which ring the kids have gone to. The parents must then scramble to find new seating. The poor level of communication often results in competitors or their parents bothering event personnel asking. “When will I be up?” or “Has my bracket been called yet?” taking away from the staff's primary tasks and reducing the ability to efficiently run the tournament, which in turn causes angst and consternation for the participants. Sometimes at national level tournaments, a “big screen” may be provided to indicate what brackets are in which rings. However, such information is not legible from more than a few rings away.

A second method is to attempt to pre-allocate brackets to rings or even matches to rings. This provides more stability and even the opportunity to estimate when matches should occur. However, a common flaw in this method is that life happens. A competitor who gets hurt or runs out to the restroom may hold up the ring and schedule for an indeterminate time. On other occasions, referee mixtures (ability to judge certain events) or needs require that a bracket be moved from one ring to another during the course of the event.

Both the first and second methods suffer from a timing problem when a bracket is reaching its final matches because one of the two final competitors must forgo a rest break and immediately fight the final match after winning a prior match. Or, a delay of several minutes must be given. With only 360 brackets, even a one minute delay adds 6-competition hours to the event.

A third method that attempts to address this rest issue does so at a cost to the spectators and adds substantial complexity. In this method, parts of the event, e.g., black belt competition, is organized around matches (independent of brackets). The matches are put into a first-in-first-out queue, with the next match in the queue sent to the next available ring. Although this gives the competitors a reasonable rest neither the competitors nor the spectators know where the competitor will go to next.

Despite such organization attempts, no appropriate balance between efficiency and communications has been managed. Idle times at the rings are still common and still cause such events to last much longer than necessary. The lack of situational awareness persists and uncomfortable confusion continues to run high for the participants and spectators.

### SUMMARY

An event coordination system for coordinating a competitive event is provided. The event coordination system includes a storage system storing an event coordination routine, event participant information, event areas information, competition information, and an event schedule, and a processing system coupled to the storage system, wherein the processing system when executing the event coordination routine is configured to retrieve the event participant information for a plurality of event participants, retrieve the event areas information and the competition information, and process the event participant information with the event areas information and the competition information and generate the event schedule for coordinating the competitive event. The event schedule coordinates the plurality of event participants over a plurality of event areas.

An event coordinator method for coordinating a competitive event is provided. The method includes obtaining event participant information for a plurality of event participants of the competitive event, obtaining event areas information of the competitive event, obtaining competition information of the competitive event, and processing the event participant information with the event areas information and the competition information and generating the event schedule for coordinating the competitive event. The event schedule coordinates the plurality of event participants over a plurality of event areas.

### BRIEF DESCRIPTION OF THE DRAWINGS

Advantages of the disclosed techniques may become apparent upon reading the following detailed description and upon reference to the drawings.

FIG. 1 shows an event coordination system in one embodiment.

FIG. 2 is a flowchart of a coordination method of a competitive event.

FIG. 3 shows an event network for a competitive event.

FIG. 4 shows a holding display generated and transmitted to a communication device of event personnel according to an embodiment.

FIG. 5 shows a ring display generated and transmitted to a communication device of event personnel according to an embodiment.

FIG. 6 shows an on-deck display generated and transmitted to a communication device of event personnel according to an embodiment.

FIG. 7 shows a holding/warm-up display generated and transmitted to a communication device of event personnel according to an embodiment.

FIG. 8 shows a chat area display generated and transmitted to a communication device of event personnel and/or event participants according to an embodiment.

FIG. 9 shows an event coordination display generated and transmitted to a communication device of event personnel and/or event participants according to an embodiment.

FIG. 10 shows a competitor queue display generated and transmitted to a communication device of event personnel and/or event participants according to an embodiment.

FIG. 11 shows a head-to-head competitor queue display generated and transmitted to a communication device of event personnel and/or event participants according to an embodiment.

FIG. 12 is a flowchart of a competitive event communication method initiated from a web-based source according to an embodiment.

FIG. 13 is a flowchart of a competitive event communication method initiated from a SMS (texting) source according to an embodiment.

FIG. 14 is a flowchart of a competitive event communicating changes in a bracket status, updating webpages and sending SMS to interested parties.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by claims and their equivalents.

An event management method and system is described that increases the situational awareness to the event staff, identifying which brackets need to be on-call, identifying which brackets are at which rings, identifying time estimates for the completion of competitor brackets at the various rings, providing direct communications between the holding manager and the ring managers, exposing most of the same information to the participants and spectators, and to facilitate the execution of the event. The invention blends the ad-hoc method with the pre-allocation method.

In one embodiment, separate functionality and views of the event activity are provided to the holding manager, to the ring managers, and to the participants and spectators.

The holding manager is provided the ability to know and control the high level activities of each bracket. The system facilitates controlling the flow of participants and brackets, moving them from a non-ready state to an on-call state, and then to a staging and holding state. The system enables the holding manager to move the bracket to a specific activity area (e.g., ring).

The ring managers are provided the ability to know and control the detailed activities of each bracket. The system facilitates activating, de-activating, and terminating a bracket. Individual presentations can be automatically (depending on the availability of related systems) or manually marked as performed. Individual matches can be put on hold, allowing automated match systems to move directly to the next match, or restored to an active state.

The system provides a time estimate for each ring, based on event specific configurations for the given activities and the number of such instances remaining in each bracket assigned to a given ring. Providing the time estimate enables the holding manager the ability to queue up the next group of participants in a timely manner, without causing hours of ready-but-waiting time. The system also provides a time cost estimate for all the remaining brackets whether they are in a non-ready state or have been activated.

The system provides an integrated instant messaging system between the holding manager, the ring managers, and other key staff members (e.g., the tournament director). This integrated messaging system blends the ability to communicate through multiple mechanisms, such as web chat and SMS. Consequently, the tournament director will not require a regular display and can be actively on the move throughout the event, relying on receiving event information by push notification.

The system provides instant messaging to competitors and spectators, depending upon the activities of interest in which they have subscribed. For example, when the holding manager activates a bracket from the non-ready state, all participants in the bracket and their coaches, (and if so requested, the parents) may receive an SMS to a number they have previously registered with the system. Similarly, when a bracket is transitioned from staging to a specific ring, the coaches, parents, and other users may receive an SMS informing them of the change.

In another embodiment, the system provides recording of scores and ranks, (e.g., win/place/show, typically as first, second, third, third (because playoffs are seldom used to determine third/fourth places for sparring) but first, second, third, fourth for presentation scored events, either automatically (depending on the availability of related systems) or manually.

In another embodiment, the system provides a web interface to spectators, informing them of the state of any given division, whether it be pre-activation, an active state, or completed. In such an embodiment, individual presentations and match scores might be made available, as well as bracket results (e.g., first, second, and third place rankings).

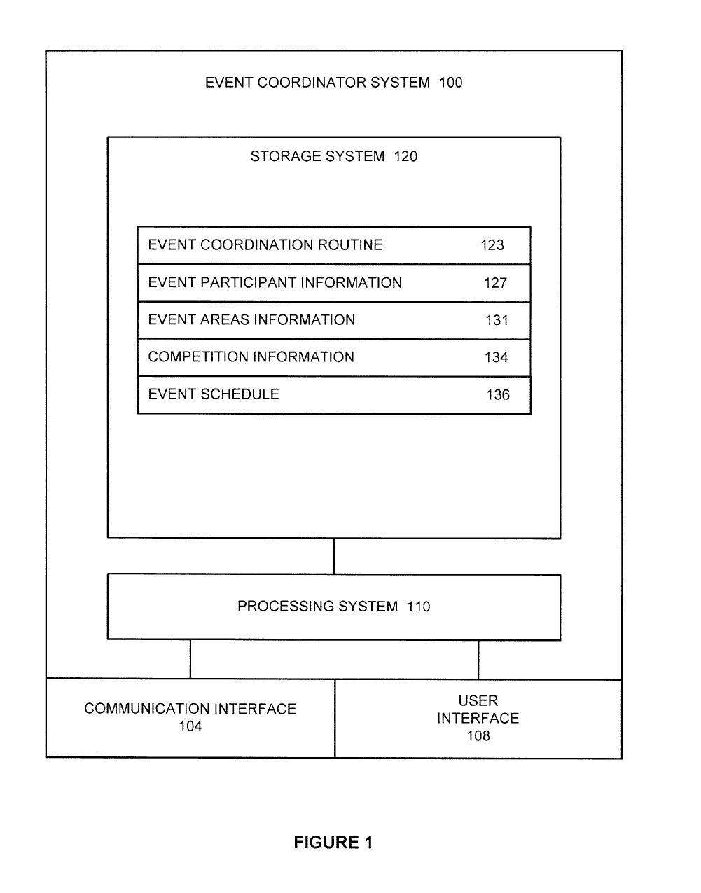

FIG. 1 shows an event coordination system 100 in one embodiment. The event coordination system 100 includes a communication interface 104, a scanning device 107, a user interface 108, a storage system 120, and a processing system 110. The processing system 110 is coupled to the communication interface 104, the scanning device 107, the user interface 108, and the storage system 120. The event coordination system 100 stores event participant information 127, event areas information 131, and competition information 134 in some examples. The event coordination system 100 processes the event participant information 127 with the event areas information 131 and with the competition information 134 to generate an event schedule 136 for coordinating the competitive event. The event schedule coordinates the plurality of event participants over the plurality of physical event areas.

The event coordination system 100 comprises a computerized device. The event coordination system 100 comprises a portable event coordination system 100 in some examples. The event coordination system 100 comprises a wireless event coordination system 100 in some examples. The event coordination system 100 can comprise a mobile device, including a cellular phone, but also may include other devices, such as subscriber equipment, customer equipment, an access terminal, a smartphone, a telephone, a mobile wireless telephone, a personal digital assistant (PDA), a computer, an e-book, a mobile Internet appliance, a wireless network interface card, a media player, a game console, or some other communication apparatus, including combinations thereof. The event coordination system 100 may be integrated within other systems and devices, such as competitive event devices, networks, or systems, or can be integrated within vehicles, appliances, apparel, and the like.

The communication interface 104 sends and receives data and/or messages. The communication interface 104 is configured to exchange communications between the event coordination system 100 and external devices, communication networks, and/or other systems. The communication interface 104 in some examples is configured to communicate with competitive event devices, networks, or systems. The communication interface 104 receives the event participant information 127, the event areas information 131, and the competition information 134 in some examples.

The communication interface 104 in some examples wirelessly exchanges communications. Alternatively, or in addition, the communication interface 104 exchanges communications over a communication medium, including wires, cables, fibers, or other suitable communication medium.

The communication interface 104 comprises communication components, such as ports, signal processing circuitry, memory, software, and the like. The communication interface 104 in the examples comprises a network card, network interface, port, or interface circuitry that allows the event coordination system 100 to communicate with other devices or systems over a variety of networks. The communication interface 104 may also include a memory device, software, processing circuitry, or some other device. The communication interface 104 may use various communication protocols to exchange communications.

The user interface 108 comprises one or both of user input devices and user output devices. The user interface 108 in some examples comprises one or more input devices for receiving user inputs, including keyboards, pointing devices, touch screens or touch sensors, audio inputs, or other input receiving/generating devices. The user interface 108 receives user inputs in some examples to generate at least some of the event participant information 127, including entry, scanning, reception, or generation of the event participant information 127.

The user interface 108 in some examples includes one or more output devices, including displays, touch screens, printers, speakers, or other output generated devices. The one or more output devices output information to a user or users of the even coordination system 100, including communicating at least a portion of the event schedule 136 to event participants and/or to event staff.

The processing system 110 comprises one or more microprocessors and other circuitry that retrieves and executes the event coordination routine 123. The processing system 110 in some examples comprises circuit boards, integrated circuitry, and associated electronics. The processing system 110 can be implemented within a single processing device but can also be distributed across multiple processing devices or sub-systems that cooperate in executing program instructions. Examples of the processing system 110 include general purpose central processing units, application specific processors, and logic devices, as well as any other type of processing device, combinations, or variations thereof. In some examples, the processing system 110 includes a computer readable storage media capable of storing the event coordination routine 123. The processing system 110 can include volatile and nonvolatile, removable and non-removable media implemented in any method or technology for storage of information, such as computer readable instructions, data structures, program modules, or other data.

In addition to storage media, in the examples the processing system 110 can also include communication media over which the event coordination routine 123 can be communicated. The processing system 110 can be implemented to include a single storage device but can also be implemented to include multiple storage devices or sub-systems co-located or distributed relative to each other. The processing system 110 can comprise additional elements, such as a controller, capable of communicating with the storage media. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media. In no case is the storage media a propagated signal.

The storage system 120 comprises non-transitory, machine-readable, data storage media, such as flash drives, disc drives, memory circuitry, servers, and the like. The storage system 120 stores the event coordination routine 123, the scan data 125, the participant identity 126, the completed check-in actions 128, and the uncompleted check-in actions 129, for example. The event coordination routine 123 comprises machine-readable instructions that control the operation of the processing system 110 when executed. The event coordination routine 123 may also include operating systems, applications, utilities, databases, and the like. All or portions of the event coordination routine 123 (and other data) may be externally stored on one or more storage media, such as flash drives, discs, servers, and the like.

The event coordination routine 122 in the examples comprises computer programs, firmware, or some other form of machine-readable processing instructions. The event coordination routine 123 may include an operating system, utilities, drivers, network interfaces, applications, virtual machines, or some other type of software. The event coordination routine 123 can include additional processes, programs, or components, such as operating system software, database software, or application software. The event coordination routine 123 can also comprise firmware or some other form of machine-readable processing instructions executable by the processing system 110.

The event participant information 127 comprises relevant competition information for participants included in the event participants 124. In some embodiments, the event participant information 127 includes one or more of a participant name and participant identifier for each participant of the plurality of event participants. In some embodiments, the event participant information 127 includes one or more of brackets information, divisions information, weight classes information, gender information, or skill level information. In some embodiments, the event participant information 127 comprises information about participants of the event being coordinated. The event participants 124 comprises information including participant names, participant addresses, participant identifiers (including membership/identifier information for a corresponding event sponsor organization, for example). The event participants 124 can include additional or other information. The event participant information 127 in some examples includes information such as an event bracket for a particular event participant, an event division for the particular event participant, an event weight or weight class of the particular event participant, a gender of the event participant, a skill level. The event participant information 127 can further include event information assigned to or corresponding to a particular event participant, such as an assigned skill level, an associated match unit time (a skill level, assigned division, or other characteristics of an event participant may determine a match unit time for the participant), an associated time per round, an associated rest time between rounds, and an associated break time between rounds.

The event areas information 131 comprises information about the event areas to be used in the competitive event. The event areas information 131 may include, for example, a number of activity areas, a number of staging areas, a number of holding areas, and a number of “not called yet” areas.

The activity areas may comprise competition rings where competitions will be held, such as sparring competitions. The activity areas may comprise activity areas where forms are performed and judged. The activity areas may comprise areas where other activities are performed, such as board-breaking, et cetera. Other activity areas may be included, and this listing is not intended to be complete or exhaustive.

The staging areas may comprise areas where next in line event competitors wait their turn for events to take place in the activity areas. The staging areas may hold one or more upcoming event competitors, waiting their turn for the activity areas.

The holding areas may comprise areas where event competitors wait to take their place in the staging areas. The holding areas in some examples may be larger than and may hold more event competitors that the staging areas.

The “not called yet” areas comprise areas where event competitors can wait to be called for the holding areas. The “not called yet” areas may comprise areas where event competitors can wait, practice, do warm-ups, or perform any other desired activities while being essentially in-queue for the holding areas, the staging areas, and ultimately the activity areas.

The number of areas in the event areas information 131 may differ from the above disclosure in some examples. The number of areas in the event areas information 131 may vary depending on the size of the competition and/or the number of participants in the competition, the number of brackets and divisions in the competition, the number of weights in the competition, or may depend on other or additional factors.

The competition information 134 comprises information about aspects of the competitive event. In some examples, the competition information 134 includes a number of activity areas of the competitive event, a number of divisions, a number of weight classes, a number of genders, and a number of skill levels, for example. In some examples, the competition information 134 includes match unit time information, total division time information, time per round information, rest time between rounds information, break time between competitions information, or setup time per match information. Other or additional competition information can be included in the competition information 134.

When executed by the processing system 110, the event coordination routine 123 directs the event coordination system 100 to retrieve the event participant information 127, the plurality of event areas information 131, and the competition information 134, process the event participant information 127 with the plurality of event areas information 131 and the competition information 134, and generate the event schedule 136 for coordinating the competitive event, wherein the event schedule 136 coordinates the plurality of event participants over a plurality of event areas.

The event schedule 136 coordinates a flow of participants into the “not called yet” areas. The event schedule 136 coordinates a flow of participants from the “not called yet” areas to the holding areas. The event schedule 136 coordinates a flow of participants from the holding areas to the staging areas. The event schedule 136 coordinates a flow of participants from the staging areas to the activity areas. It should be understood that the number of staging areas may be the same as or different from the staging areas, the holding areas, and/or the “not called yet” areas. As a result, in some examples the event schedule 136 coordinates movement of a particular event participant to a particular “not called yet” area, from the particular “not called yet” area to a particular holding area, from the particular holding area to a particular staging area, and from the particular staging area to a particular activity area.

The event schedule 136 coordinates a flow of participants based on, for example, a number of activity areas, a number of staging areas, a number of holding areas, and a number of “not called yet” areas. The event schedule 136 coordinates a flow of participants based on, for example, a number of brackets, a number of divisions, a number of weights, and the genders and skill levels of the event participants.

The event schedule 136 coordinates a flow of participants based on, for example, a match unit time of each scheduled match, a total division time of time allotted to each division in the competitive event, a time per found of each scheduled match, a rest time between rounds of each scheduled match, a break time between rounds of each scheduled match, a break time between competitions, and a setup time per match, or combinations thereof.

It should be understood that a match unit time of each scheduled match may vary depending on characteristics of the competitors involved in the match. Likewise, the time per round, rest time between rounds may depend on characteristics of the competitors involved in the match. It should therefore be understood that a match unit time of each scheduled match may vary depending on the gender and skill level of the match participants. It should be understood that a match unit time of each scheduled match may vary depending on the bracket of the match participants. It should be understood that a match unit time of each scheduled match may vary depending on the division of the match participants.

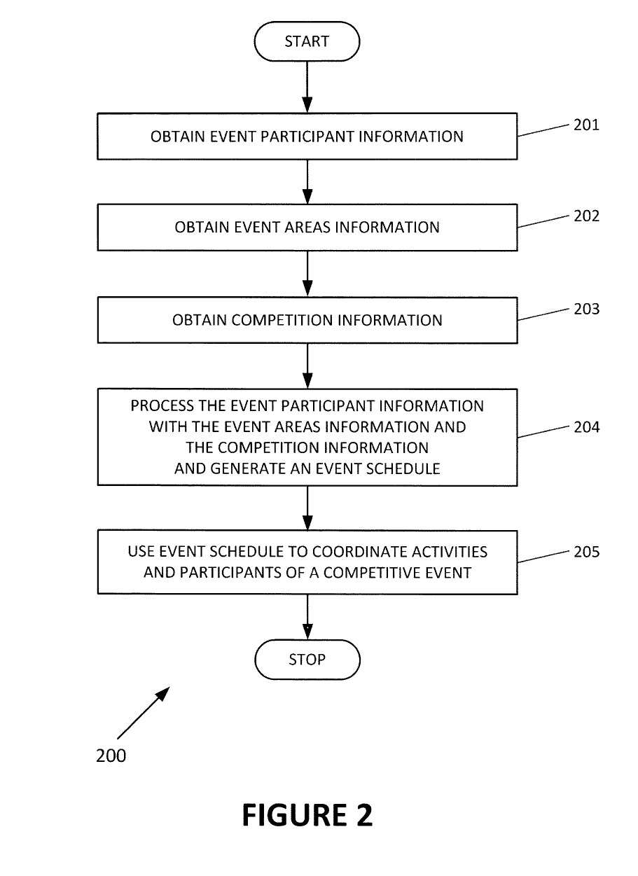

FIG. 2 is a flowchart 200 of a coordination method of a competitive event. In some embodiments the method is performed by an event coordination system, for example. In step 201, an event coordination system obtains event participant information for a plurality of event participants of the competitive event. The event participant information in some embodiments includes one or more of a participant name and participant identifier for each participant of the plurality of event participants. The event participant information in some embodiments includes one or more of bracket information, division information, weight class information, gender information, or skill level information for one or more event participants, including combinations thereof. It should be understood that other or additional categorizations can be included in the event participant information.

In step 202, the event coordination system obtains event areas information. The event areas information includes information about specific physical areas of the competitive event that are to be scheduled by the coordination method. The event areas in some examples include “not called yet” areas of the event venue, holding areas of the event venue, staging areas of the event venue, activity areas of the event venue, or combinations thereof.

In step 203, the event coordination system obtains competition information. The competition information comprises competition-specific information. In some examples, the competition information comprises a number of activity areas and/or a number of weight classes of the competitive event. In some examples, the competition information comprises match unit time information, time per round information, rest time between rounds information, break time between competitions information, setup time per match information, total division time information, or combinations thereof.

In step 204, the event coordination system processes the event participant information with the event areas information and the competition information to generate an event schedule for coordinating the competitive event.

In step 205, the event schedule coordinates a plurality of event activities and a plurality of event participants of the competitive event. The event schedule coordinates the plurality of event participants over the plurality of physical event areas.

From the perspective of an individual participant, the event schedule coordinates movement of a particular event participant to a particular “not called yet” area, from the particular “not called yet” area to a particular holding area, from the particular holding areas to a particular staging area, and from the particular staging area to a particular activity area. From the perspective of the competitive event as a whole, the event schedule coordinates movement of various numbers of participants into “not called yet” areas, movement of participants from “not called yet” areas to holding areas, movement of participants from holding areas to staging areas, and movement of participants from staging areas to activity areas.

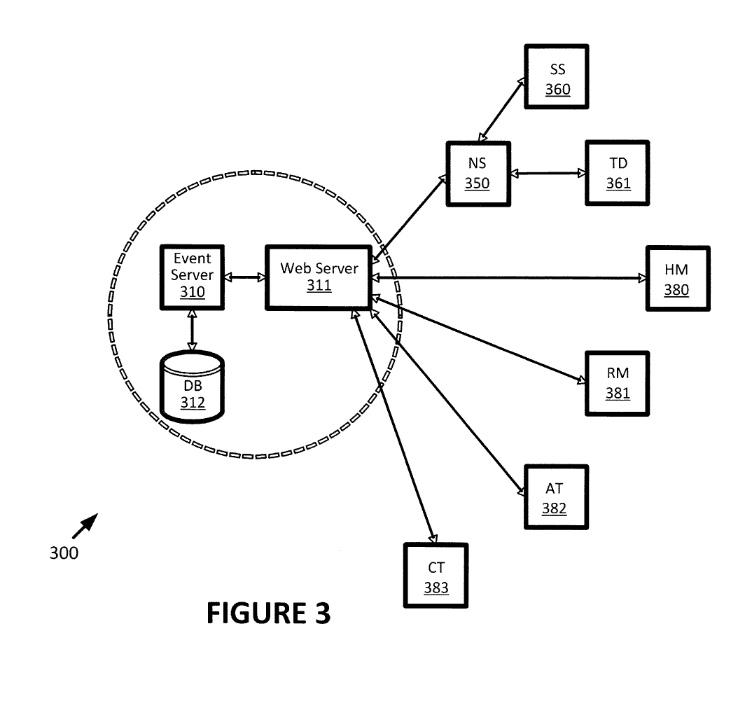

FIG. 3 shows an event network 300 for a competitive event. The event network 300 includes an event server 310 configured to perform event functions. The event server 310 is communicatively coupled to a database (DB) 312 and to a web server 311. The database 312 stores event information, including the event participant information 127, the event areas information 131, and the competition information 134. The event server 310 in some embodiments stores and executes the event coordination routine 123, as previously discussed.

The web server 311 comprises a server that interfaces with the internet (not shown) and exchanges communications using one or more internet-applicable communication protocols. The web server 311 in some embodiments performs common communication and web-interface functions, for example. However, it should be understood that the web server 311 can perform other and/or additional functions.

In the example shown, the web server 311 interfaces between the event server 310 and other devices, including a notification server (NS) 350, a support staff device or terminal (SS) 360, a Tournament Director (TD) 361, a Holding Manager (HIM) 380, a Ring Manager (RM) 381, an awards table (AT) 382, and a check-in table (CT) 383. The web server 311 can send information to and receive information from each of these components. Event personnel can have communication devices that enable the event personnel to obtain event coordination data from the event server 310, via the web server 311. For example, a ring manager, responsible for conducting event activities at a specific ring or rings, can use the RM 181 to receive event coordination data for the ring managers specific ring or rings, enabling the ring manager to conduct competition activities in an organized and efficient manner.

The NS 350 in some embodiments comprises a communication device or devices used for exchanging communications between the web server 311 and the SS 360 and TD 361, as shown, where the SS 360 and TD 361 are more readily available via SMS or pager. The SS 360 and TD 361 may be available via websockets, webchat, or similar web based connections, but those mechanisms may not be as convenient or as effective at capturing attention to a person on the move in a noise environment. Alternatively, or in addition, the NS 350 also exchanges communications between the web server 311 and the HM 380, the RM 381, the AT 382, and the CT 383.

The SS 360 in some embodiments comprises a communication device or devices used by support staff for various tasks, events, and/or details of a competitive event. The SS 360 can provide a variety of information, as disclosed in any of the embodiments herein.

The TD 361 in some embodiments comprises a communication device or devices used by the tournament director for managing event participants and event areas of a tournament. The TD 361 can be used to coordinate the flow of event participants through a tournament. The TD 361 can be used to coordinate events, including coordinating brackets, rankings, and weights, for example. The TD 361 can be used to respond to the unexpected issues that inevitably arise.

The HM 380 in some embodiments comprises a communication device or devices used by holding managers for managing holding areas. The HM 380 can be used to coordinate the flow of event participants through a particular holding area or areas corresponding to a particular holding manager.

The RM 381 in some embodiments comprises a communication device or devices used by ring managers for managing ring or activity areas. The RM 381 can be used to coordinate the flow of event participants through a particular ring or rings corresponding to a particular event manager.

The AT 382 in some embodiments comprises a communication device or devices used for performing competition scoring analysis and awards assignment. The AT 382 can process information by gender, weight, ranking, bracket, et cetera, and can determine the winners and rankings when event competitions have been completed (or as match information is received).

The CT 383 in some embodiments comprises a communication device or devices used for performing event check-in. The CT 383 can verify attendance of event participants, can be used to determine event participants who are absent, and can obtain other and additional event participant information.

The event coordination system facilitates tournament execution by helping event managers and event personnel control the flow of event participants and brackets/divisions move from a non-ready state, into a holding region, then to a staging region, move out to their activity area (e.g., ring), through the activities at the ring, and onto completion. The event coordination system in some examples operates on previously encoded/received event participants. The event participants are broken down by age groups, genders, skill level (e.g., belt ranks), and weight category (e.g., Fin, Fly). In a state championship, for example, the number of divisions can easily exceed 600.

The event coordination system encodes time estimates by division. This includes time per round (e.g. multiple sparring rounds in a sparring match), rest time between rounds, break time between competitors, setup time per match (e.g., for testing electronic scoring mechanisms to ensure they work). For example, 6-7 year olds might tight two, one minute-rounds, with a 30 second rest between. The time between the competitors bowing, greeting other coaches, and getting the next competitors on the mat might be one minute. The time to perform test kicks, to ensure the scoring gear works correctly might take another minute. However, for an adult competitor, the sparring might consist of three, two minute rounds with a 60 second break. The unit time (e.g., of a match) and remaining total division time estimates are stored in the database.

The event coordination system facilitates the tasks of a staging manager. A staging manager (who moves competitors through the major flow mechanisms) is presented a page which displays all N rings (activity areas), a segment for “staged” divisions, divisions in “holding”, and a subset of the divisions “not called yet” which are next to be called into holding. “Not called yet” divisions initially includes all 600+ divisions, of which a small subset, e.g., ten to twenty, may be visible, with the remainder available to be scrolled into view. When the staging manager is ready, he “calls” up some quantity of these divisions into the holding area. The participants in these divisions now come into a specific area to be ready to be called up to action. From the holding area, the participants of a division will be called into “staging” where their presence is checked against a list of who is in the division and is the division ready to go. These participants are lined up awaiting deployment to an activity area. The staging manager then assigns a staged division to a ring of their choice. In an alternative embodiment, a computer algorithm automatically determines where best to assign a division, where the computer algorithm, including load balancing optimization algorithms, can be performed in advance, or dynamically based on the current state of the event.

At this high level, the display comprises components/objects/clusters of information to be represented. The display may include a division, including estimated time, division number & name, division components (e.g., age range, gender, skill range, weight range). The display may include a collection area, including (e.g., staging, holding, not-called-yet). These are nominally ordered by division number (but need not be used in that exact order). The display may include an activity area, including queue size graphical indicator to display remaining activity time with color-coding to highlight when more activity needs to be added to the area, a numeric display of how long the area is currently set to be engaged (the queue time as a number, in hours:minutes:seconds), and a collection of division components.

A ring manager (who handles one or more rings, most likely two), is displayed a set of the information similar to what the staging manager sees. One set of widgets & data is shown for each ring being managed. The information overlaps what is seen by the staging manager with additional information and control capabilities specific to the responsibilities of the ring manager. The information is broken into three segments. The queue is displayed as for the staging manager. Changes made by the staging manager show up on the ring manager's display. An active division (and related detail information) is displayed. An area for completing a division is displayed. A drag-and-drop implementation may allow the ring manager to move a division “down” from the queue, then to active, then to complete. The ring manager may also suspend activity for a division by moving it back up into the queued area. When moved to completed, the match gets removed from both the ring manager and the staging manager's displays. When a division is moved into the active area, related information is displayed, including a queued list of participants (in this embodiment, on a match by match basis), the overall bracket showing the context of the activity, and individual “match sheets” (a match sheet indicates the participants, identifies who is in blue/red, and provides additional information to referees, who use the sheet as a “scratch pad” indicating penalties, contested calls, etc.). These displays are refreshed at an appropriate rate, which may be by match or by periodic time. In the preferred embodiment, a staging manager's display is updated at predetermined intervals, such as once per minute, while the ring manager's display is updated at individual match completions, for example.

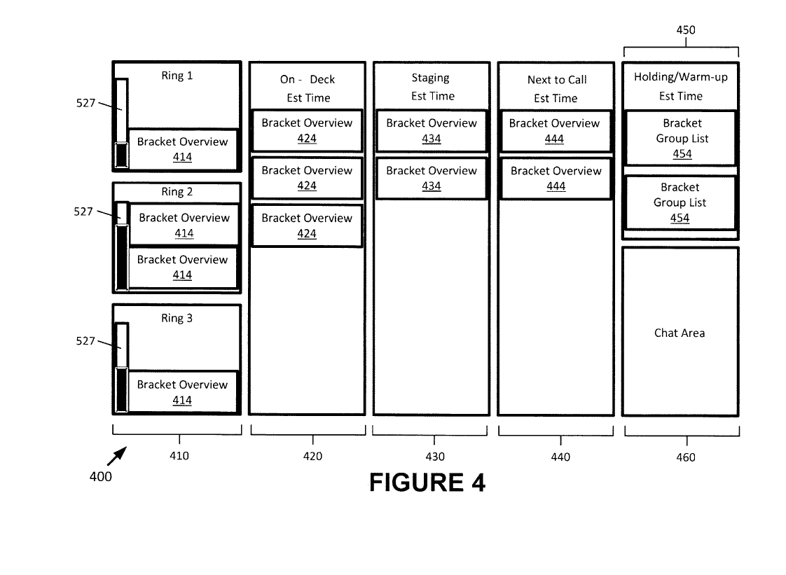

FIG. 4 shows a holding display 400 generated and transmitted to a communication device of event personnel according to an embodiment. In some examples, the holding display 400 is generated on the HM 180 of a holding manager, but could be generated on other devices as well. The holding display 400 in the embodiment shown includes ring displays 410, an on-deck display 420, a staging display 430, a next to call display 440, a holding/warm-up display 450, and a chat area 460.

The ring displays 410 include displays for each event ring assigned to the event holding manager, bracket overview displays 414, and an accompanying remaining time indicator 416 for each associated ring. The remaining time indicators 416 in the embodiment shown comprise status bars that move or fill or empty, and change color, according to the time remaining for the associated ring. The remaining time indicators 416 display remaining times for a current brackets being handled in the particular ring.

The on-deck display 420 displays bracket overviews that are on-deck and will be up soon. The on-deck display 420 enables planning and sequencing of participants and events that are not currently being conducted in the particular ring or rings, but are upcoming. Although three bracket overviews are shown, it should be understood that the on-deck display 420 can display any desired number of on-deck brackets. The display of on-deck brackets may enable event participants, coaches, staff, family, and other event attendees to plan their movements. The display of on-deck brackets may enable event participants and others to know when to arrive at appropriate pre-event areas, such as a “not called yet” area, a holding area, and a staging area, for example. The on-deck display 420 can include one or more bracket overview displays 424 for associated competition brackets.

The staging display 430 displays bracket overviews of brackets where corresponding event participants are being held in a staging area or areas. The staging area or areas hold event participants to be called up to the on-deck area or areas, as event participants are moved from the on-deck area or areas to the rings. The staging display 430 can include one or more bracket overview displays 434 for associated competition brackets.

The next to call display 440 displays bracket overviews of brackets where corresponding event participants are being held in a next to call area or areas. The next to call area or areas hold event participants to be called up to the staging area or areas, as event participants are moved from the staging area or areas to the on-deck area or areas. The next to call display 440 can include one or more bracket overview displays 444 for associated competition brackets.

The holding/warm-up display 450 displays bracket overviews of brackets where corresponding event participants are being held in a holding/warm-up area or areas. The holding/warm-up area or areas hold event participants to be called up to the next to call area or areas, as event participants are moved from the next to call area or areas to the staging area or areas. The holding/warm-up display 450 can include one or more bracket overview displays 454 for associated competition brackets.

The chat area 460 displays chat messages of event participants who have been assigned to the associated rings. The event participants can post chat messages to other participants. The event participants can post chat messages to event personnel. In addition, the holding manager can post chat messages to event participants or other event personnel. The chat area 460 provides a communication forum, wherein event participants and event personnel can quickly and easily communicate. Further, event participants and event personnel can observe and pick up information posted in the chat area 460, wherein the chat area 460 can perform the function of a bulletin board or announcement area. The chat area 460 can hold posted messages for a predetermined period of time, so that event participants and event personnel can check the chat area 460 at their convenience and not miss a message or announcement.

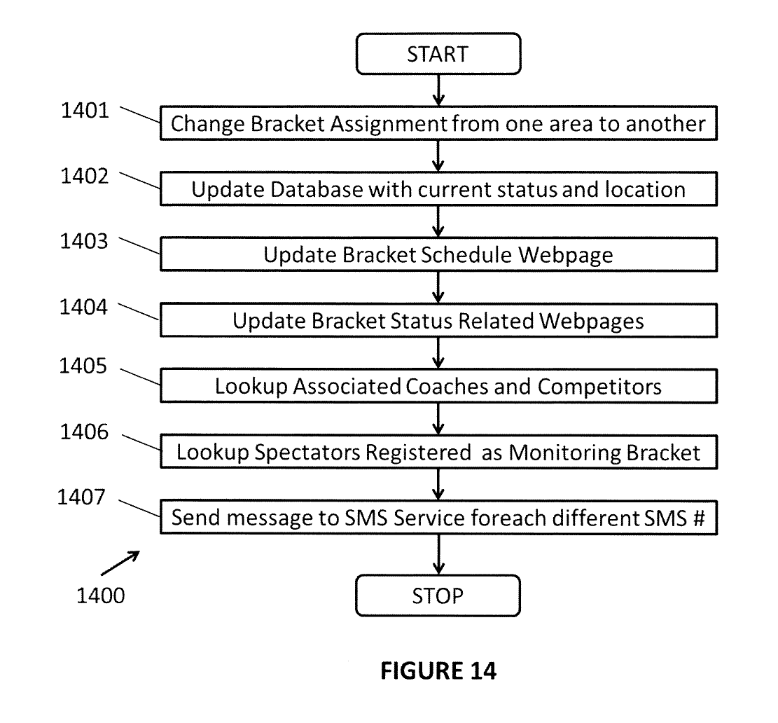

Brackets are transitioned from one event area to another primarily using a drag-and-drop technique. Each time a bracket is transitioned, the algorithm embodied by the flowchart of FIG. 14 is invoked. All of the coaches, participants, registered spectators interested in the given bracket may be notified via SMS according to an embodiment, or other notification mechanism, that a significant change has occurred. The text message contains a link to a web page showing the current state of the given bracket. Further the bracket schedule web page is updated to indicate the change in bracket state to inform the other spectators monitoring the event.

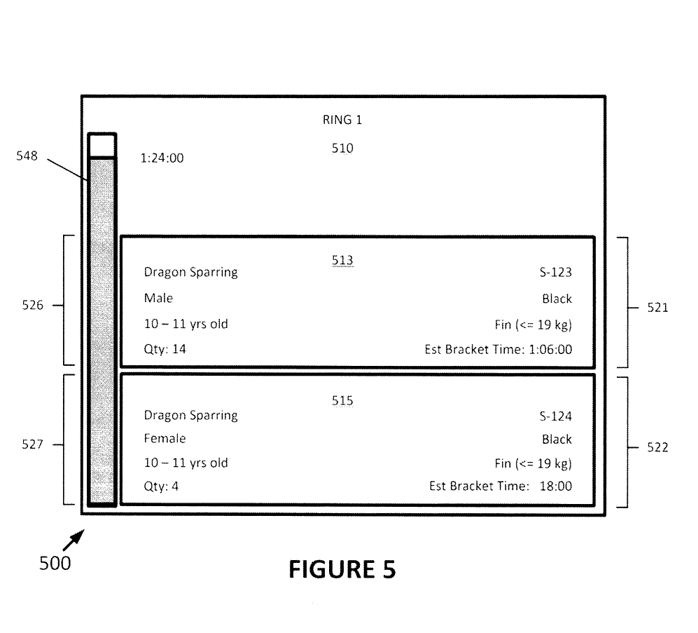

FIG. 5 shows a ring display 500 generated and transmitted to a communication device of event personnel according to an embodiment. In some examples, the ring display 500 may be generated on the RM 181 of a ring manager, but could be generated on other devices as well. The ring display 500 in the embodiment shown includes a ring display 510, a male participant display 513, a female participant display 515, and a remaining time indicator 548.

The ring display 500 displays information regarding an activity area/ring assigned to a particular ring manager. The ring display 500 displays information that enables the ring manager to plan and execute individual event sessions with the associated event participants.

The male participant display 513 displays information regarding male participants assigned to the particular ring and/or particular ring manager. The male participant display 513 includes information including an event type (“dragon sparring” in the example), a “male” label, an age range, and a number of male participants on the left side of the male participant display 513. The male participant display 513 includes information including an event classification (“S-123” in the example), a belt level/color, a weight class, and an estimated bracket time on the right side of the male participant display 513. The estimated bracket time comprises an estimated time that will be required to process all fourteen of the male competitors in the example.

The female participant display 515 displays information regarding female participants assigned to the particular ring and/or particular ring manager. The female participant display 515 includes information including an event type (“dragon sparring” in the example), a “male” label, an age range, and a number of male participants on the left side of the female participant display 515. The female participant display 515 includes information including an event classification (“S-124” in the example), a belt level/color, a weight class, and an estimated bracket time on the right side of the female participant display 515. The estimated bracket time comprises an estimated time that will be required to process all four of the female competitors in the example.

The remaining time indicator 548 gives a visual indication of remaining time for the specified ring and specified event competitors. The total remaining time indicator 548 in the embodiment shown comprises a status bar that moves or fills or empties according to the amount of time remaining for the associated ring. In addition to displaying the total remaining time in the given area, the status bar is also color-coded to provide a quick and easy to understand visual indication of the status of Ring 1. Another embodiment might provide shading, texture, or other visual queueing techniques. The preferred embodiment uses remaining time in preference to bracket completion time or completion percentage because the primary need of the event management team is to keep the rings busy; a red status bar with a reading of 5-minutes remaining is more effective than indicating 98% completion.

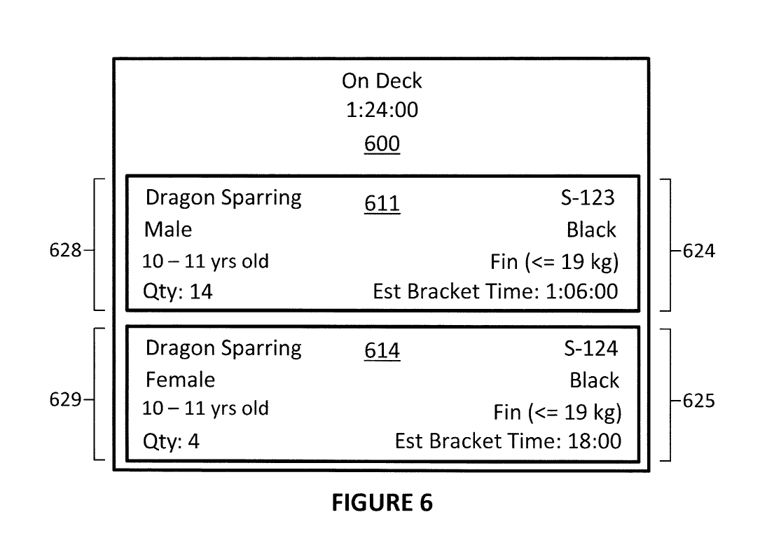

FIG. 6 shows an on-deck display 600 generated and transmitted to a communication device of event personnel according to an embodiment. In some examples, the on-deck display 600 may be generated on the RM 181 of a ring manager or on the HM 180 of a holding manager, but could be generated on other devices as well. The on-deck display 600 in the embodiment shown includes a male participant display 611 and a female participant display 614. The on-deck display 600 shows event participants held in an on-deck or staging waiting area. Typically, event participants being held in the on-deck or staging waiting area will subsequently be moved to an activity area, such as a competition ring, for example.

The male participant display 611 displays information regarding male participants assigned to the particular ring and/or particular ring manager. The male participant display 611 includes information including an event type (“dragon sparring” in the example), a “male” label, an age range, and a number of male participants on the left side of the male participant display 611. The male participant display 611 includes information including an event classification (“S-123” in the example), a belt level/color, a weight class, and an estimated bracket time on the right side. The estimated bracket time comprises an estimated time that will be required to process all fourteen of the male competitors in the example.

The female participant display 614 displays information regarding female participants assigned to the particular ring and/or particular ring manager. The female participant display 614 includes information including an event type (“dragon sparring” in the example), a “female” label, an age range, and a number of female participants on the left side of the female participant display 614. The female participant display 614 includes information including an event classification (“S-124” in the example), a belt level/color, a weight class, and an estimated bracket time on the right side. The estimated bracket time comprises an estimated time that will be required to process all four of the female competitors in the example.

It can be seen that the estimated bracket times may accompany a group of event participants as the event participants move through the various holding areas. However, the estimated bracket times may change, depending on factors such as changes in previous matches/brackets, changes in the number of event participants, et cetera.

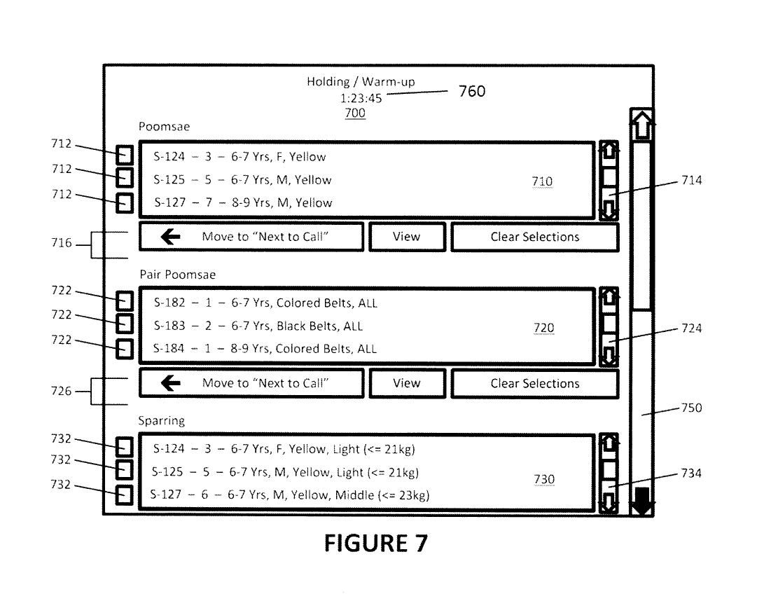

FIG. 7 shows a holding/warm-up display 700 generated and transmitted to a communication device of event personnel according to an embodiment. In some examples, the holding/warm-up display 700 may be generated on the RM 181 of a ring manager or on the HM 180 of a holding manager, but could be generated on other devices as well. The holding/warm-up display 700 in the embodiment shown includes competitive event displays 710, 720, and 730. Each competitive event display 710, 720, or 730 includes checkboxes 712, 722, or 732 that can be checked when the corresponding events are to be acted upon by the action buttons 716, 726. The corresponding events include information including competitive event identifier, a number of corresponding event participants, a corresponding age group or age range, a competitor gender, a belt color or belt level, and a weight class. In an alternate embodiment, the time estimate of the bracket for the given number of participants may also be displayed. The corresponding events further include scrolling mechanisms 714, 724, 734, and 750. The holding/warm-up display 700 further includes an overall remaining time indicator 760 that gives a visual indication of remaining time for the holding/warm-up display 700.

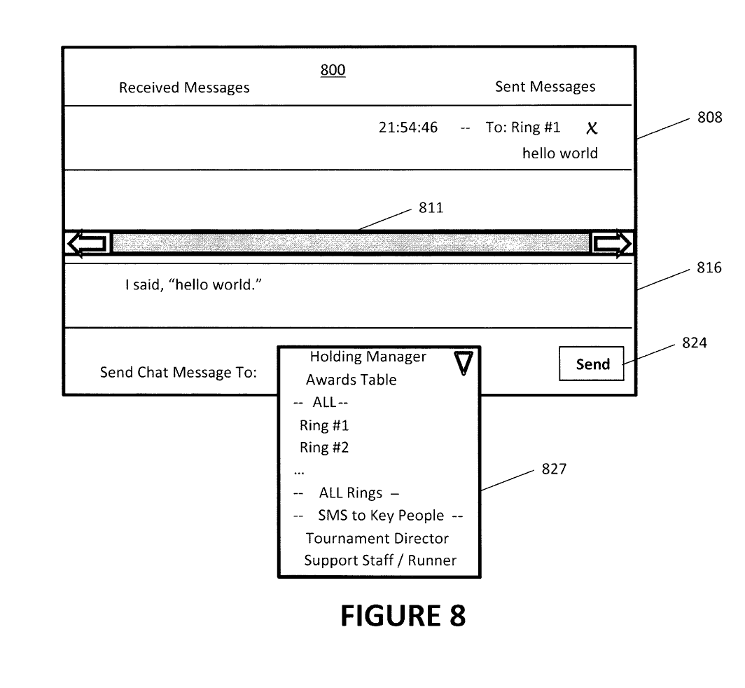

FIG. 8 shows a chat area display 800 generated and transmitted to a communication device of event personnel and/or event participants according to an embodiment. In some examples, the chat area display 800 may be generated on the RM 181 of a ring manager or on the HM 180 of a holding manager, but could be generated on other devices as well, including on communication devices of event participants and on the communication devices of event participant friends and family, for example. The chat area display 800 in the embodiment shown includes a message transmission history area 808, a message transmission status scroll bar 811, a received message area 816, a message address portion 827, and a message send button 824.

The message transmission area 808 displays one or more received chat messages. The one or more received chat messages can be of any chat message type or protocol. The message transmission status bar 811 shows the completion status of a chat message transmission, for example. Alternatively, or in addition, the status bar 811 can be used to move between received chat messages, to enable display of more than one chat message within the chat area display 800. The received message area 816 comprises an area wherein the owner or user of the communication device can compose and transmit chat messages. The message address portion 827 enables the owner or user to select a chat message recipient or an address or identifier of a recipient. The message send button 824 enables the owner or user to transmit a chat message composed within the received message area 816.

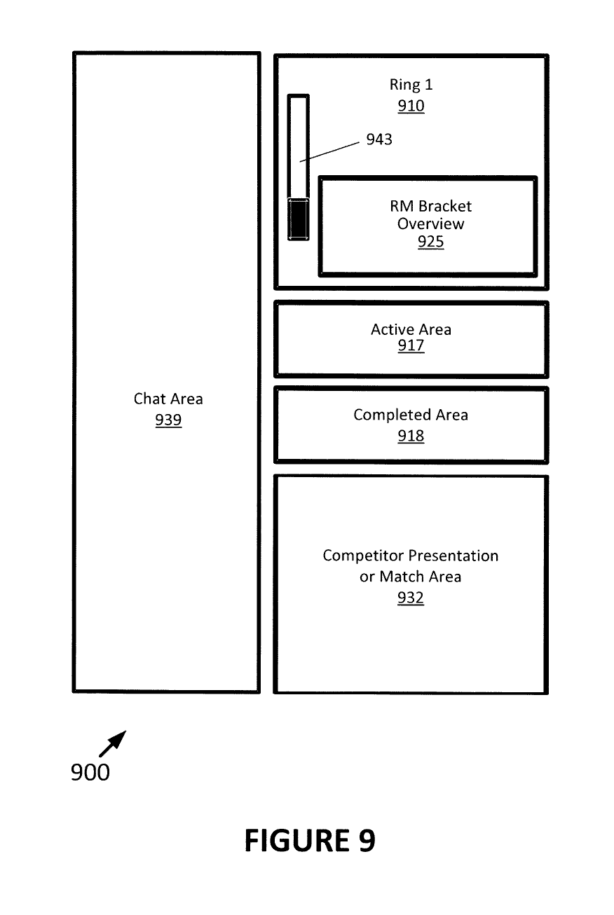

FIG. 9 shows an event coordination display 900 generated and transmitted to a communication device of event personnel and/or event participants according to an embodiment. In some examples, the event coordination display 900 may be generated on communication devices of event participants and on the communication devices of event participant friends and family. The event coordination display 900 may also be generated on the RM 181 of a ring manager or on the HM 180 of a holding manager. The event coordination display 900 may provide situational awareness and control to a ring manager.

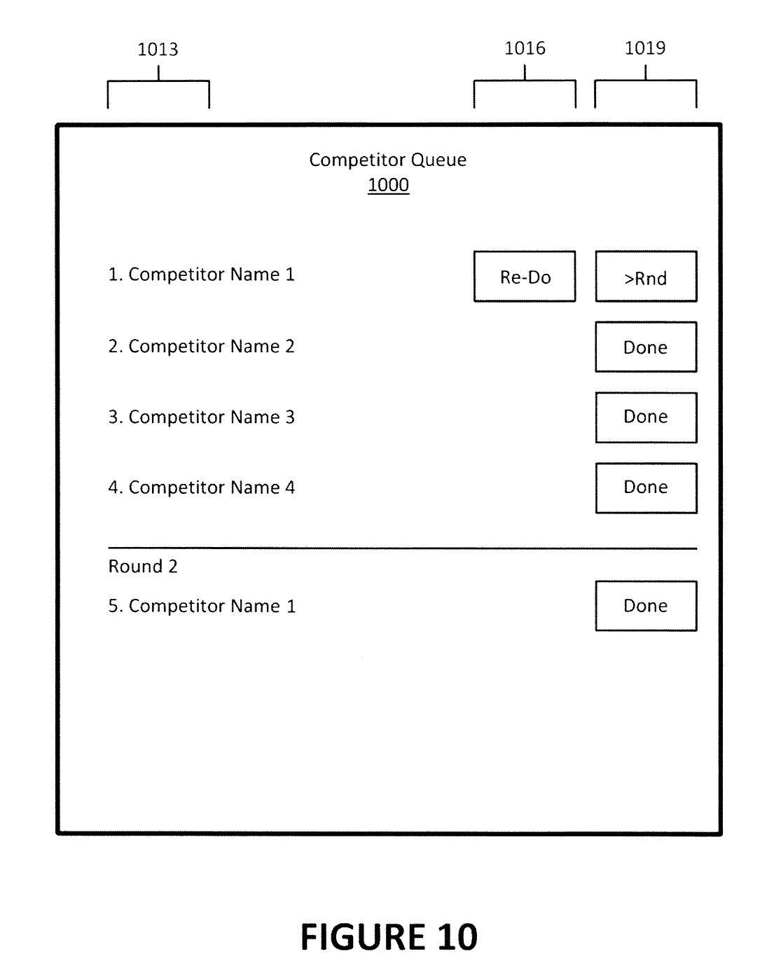

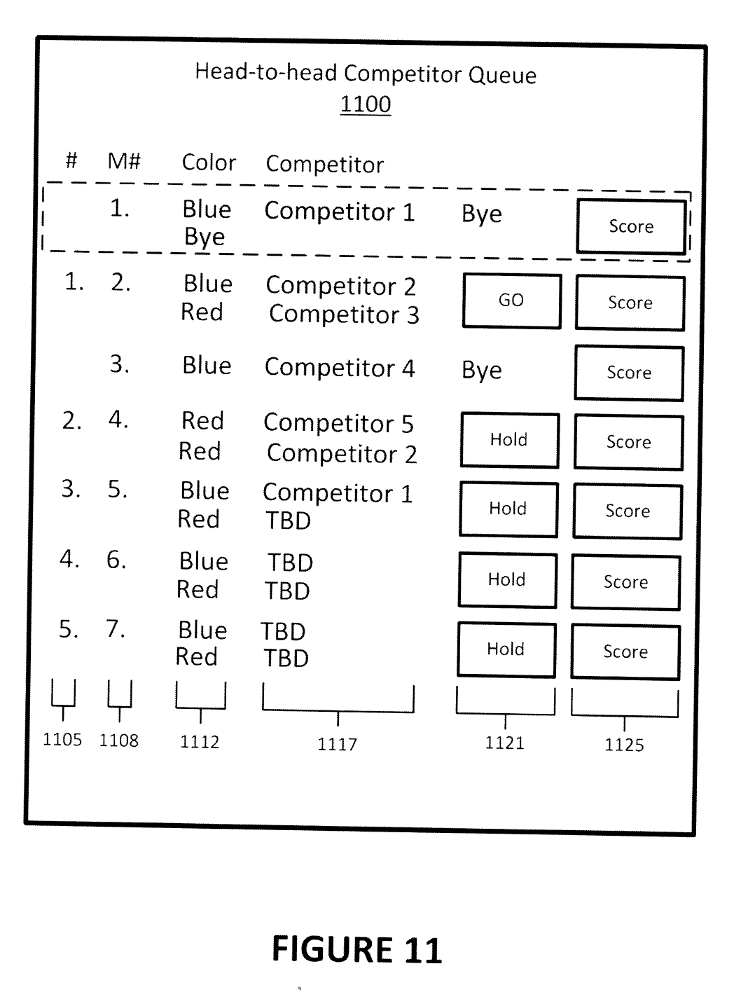

The event coordination display 900 in the embodiment shown includes a ring display 910, an active area display 917, a completed area display 918, a competitor presentation or match area display 932, and a chat area 939. The ring display 910 displays information associated with a particular ring or activity area. The ring display 910 includes a remaining time indicator 943 and a ring manager (RM) bracket overview display 925. The remaining time indicator 943 gives a visual indication of remaining time for the specified ring. The RM bracket overview display 925 may include some or all bracket information associated with the ring. The active area 917 in some examples displays information about the bracket currently active in the event area. The completed area 918 in some examples is used as a logical recycle bin or trash bin, where the bracket is dragged into to indicate completion. In another embodiment, the completed area 918 could be displayed as a stack of past events, with the most recent showing, and mechanisms to ‘scroll’ through the list. The competitor presentation or match area 932 in some examples displays event competitors and competitor information for event participants currently engaged in a competitive event. The competitor presentation or match area 932 in some examples displays information concerning activity of a corresponding ring or activity area as presented in FIG. 10 and FIG. 11.

The chat area 939 displays chat messages of event participants who have been assigned to the associated rings. The event participants can post chat messages to other participants. The event participants can post chat messages to event personnel. In addition, the holding manager can post chat messages to event participants or other event personnel. The chat area 939 provides a communication forum, wherein event participants and event personnel can quickly and easily communicate. Further, event participants and event personnel can observe and pick up information posted in the chat area 939, wherein the chat area 939 can perform the function of a bulletin board or announcement area. The chat area 939 can hold posted messages for a predetermined period of time, so that event participants and event personnel can check the chat area 939 at their convenience and not miss a message or announcement.

FIG. 10 shows a competitor queue display 1000 generated and transmitted to a communication device of event personnel and/or event participants according to an embodiment. In some examples, the competitor queue display 1000 may be generated on communication devices of event participants and on communication devices of event participants' friends and family. The competitor queue display 1000 may also be generated on the RM 181 of a ring manager or on the HM 180 of a holding manager. The competitor queue display 1000 may provide situational awareness and control to a ring manager.

The competitor queue display 1000 in the embodiment shown includes event participant identifiers 1013, primary action buttons 1019 for the HM 180 to update status information relating to the corresponding event participant, and additional (correct for human error) action buttons 1016 for the corresponding event participant. The competitor queue display 1000 therefore gives an easily understood graphical display of event participants and their associated status. In another embodiment, action buttons for manually scoring the competitor performance are also provided.

FIG. 11 shows a head-to-head competitor queue display 1100 generated and transmitted to a communication device of event personnel and/or event participants according to an embodiment. In some examples, the head-to-head competitor queue display 1100 may be generated on communication devices of event participants and on communication devices of event participants' friends and family. The head-to-head competitor queue display 1100 may also be generated on the RM 181 of a ring manager or on the HM 180 of a holding manager. The head-to-head competitor queue display 1100 may provide situational awareness and control to a ring manager. The head-to-head competitor queue display 1100 may be in addition to or an alternative to the competitor queue display 1000 of FIG. 10.

The head-to-head competitor queue display 1100 in the embodiment shown includes next match counters 1105, bracket match numbers 1108, sparing gear color 1112, event participant information 1117, additional match information, results, or action buttons 1121, and match scoring action buttons 1125. The head-to-head competitor queue display 1100 therefore provides an easily understood graphical display of pairs of event participants who have or will be competing in individual matches.

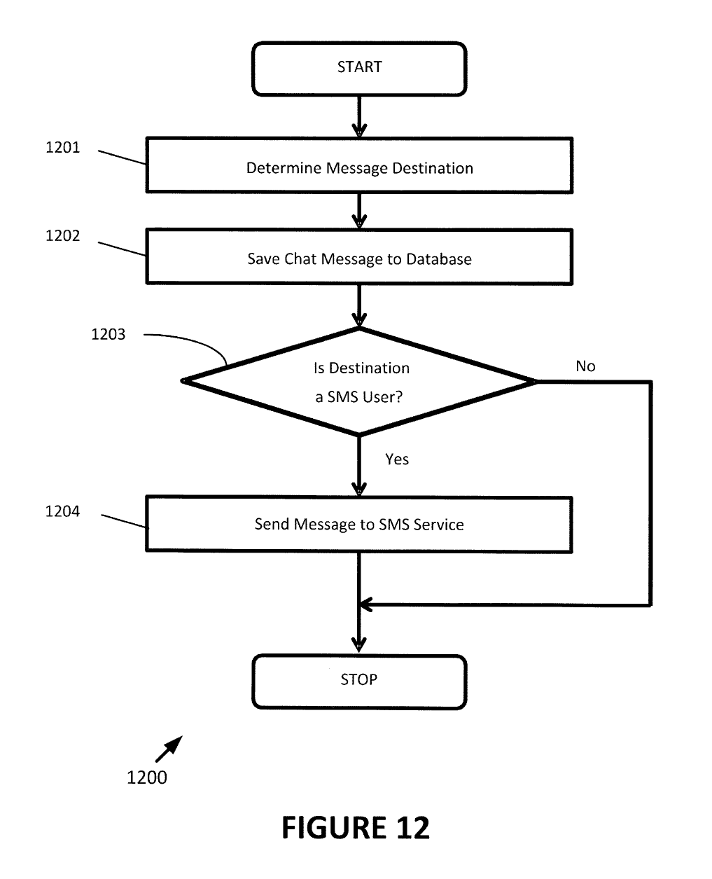

FIG. 12 is a flowchart of a competitive event communication method initiated from a web-based source according to an embodiment. In step 1201, where a communication message has been generated, the communication device generating the message determines a destination of the message. The communication device can comprise a device of event personnel, event competitors, or competitors' friends and family, for example. The communication message can comprise a short message service (SMS) message, for example, but alternatively can comprise any form of suitable message that can be transmitted between communication devices of event personnel, or competitors' friends and family. The communication message can comprise a short text message, including chat messages, and will be referred to as a chat message below for convenience.

In step 1202, the communication device transmits the communication message to a database where a copy of the communication message is saved. The saving of the communication message does not interfere with transmitting the communication message to an intended destination.

In step 1203, if the destination is capable of receiving the communication message, then the method proceeds to step 1204. For example, where the communication message comprises a SMS message, the method determines if the destination is a SMS message user. If the destination is not capable of receiving the communication message, the message bypasses step 1204.

In step 1204, the communication message is transmitted to the destination.

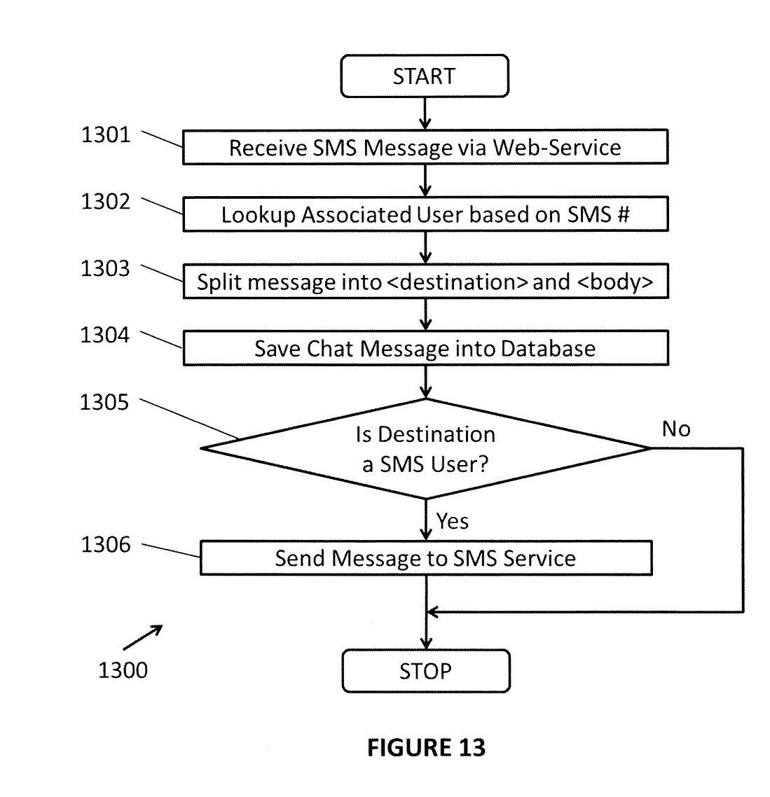

FIG. 13 is a flowchart of a competitive event communication method initiated from a SMS (texting) source according to an embodiment. In step 1301, a communication message has been received as a web-service call, e.g., as invoked by an SMS Messaging service.

In step 1302, the system looks up the registered user, whether staff, competitor, or spectator, based on the source SMS number. This information is held for step 1304.

In step 1303, the system splits the text of the message based on a delimiter, such as a colon, ‘:’, or pipe ‘|’ to identify a destination component and actual message content.

In step 1304, the user identity from step 1302 and the destination and message components from step 1303 are stored into the database. The saving of the communication message does not interfere with transmitting the communication message to an intended destination.

In step 1305, if the destination is capable of receiving the communication message (e.g., the destination is a SMS user), then the method proceeds to step 1306. For example, where the communication message comprises a SMS message, the method determines if the destination is a SMS message user. If the destination is not capable of receiving the communication message, the message bypasses step 1306.

In step 1306, the communication message is transmitted to the SMS destination.

FIG. 14 is a flowchart of a method for a competitive event in communicating changes in a bracket status, updating webpages and sending SMS message updates to interested parties. The method therefore communicates changes in the event schedule. In some embodiments, the method communicates changes in the event schedule in real-time or near real-time. In some embodiments, the changes in the event schedule are communicated using one or both of passive and active communication mechanisms. The changes in the event schedule can be communicated to one or more of event personnel, event participants, and event spectators. In step 1401, the holding manager (or other appropriate event personnel) has changed a bracket assignment from one event area to another.

In step 1402, the database is updated with the new event area information.

In step 1403, a web page is updated with the new event area, with the web page informing coaches, competitors, parents, and other spectators of the new event area. Such web pages are considered a passive notification mechanism as the page must be requested for viewing by the participant.

In step 1404, other web pages which convey status information about the event area for the bracket are updated with the new area, and possibly the time at which the change has been made. For example, the web page which is the destination of the link, embedded in the message in step 1407 is updated.

In step 1405, information regarding coaches and competitors associated with the specific bracket are retrieved from the system and their SMS #s are collected for use in step 1407.

In step 1406, spectators registered as having an interest in changes to the specific bracket are retrieved from the system and their SMS numbers are collected for use in step 1407.

In step 1407, a message is sent to each unique SMS number collected in steps 1405 and 1406. Such messages are considered an active notification mechanism as the notification is ‘pushed’ to the user and typically received as an interruption to their normal activity, e.g., via vibration, ring tone, or changes in lighting (often used by the deaf community). It should be noted that SMS, pager, or any appropriate notification mechanism may be used.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. An event coordination system for coordinating a competitive event, the system comprising:
a storage system storing an event coordination routine, event participant information, event areas information, competition information, and an event schedule; and
a processing system coupled to the storage system, wherein the processing system when executing the event coordination routine is configured to:
retrieve the event participant information for a plurality of event participants;
retrieve the event areas information and the competition information; and
process the event participant information with the event areas information and the competition information and generate the event schedule for coordinating the competitive event, wherein the event schedule coordinates the plurality of event participants over a plurality of event areas.

2. The event coordination system of claim 1, with the event participant information including a plurality of event participants.

3. The event coordination system of claim 1, with the event participant information comprising one or more of a participant name and participant identifier for each participant of the plurality of event participants.

4. The event coordination system of claim 1, with the event participant information comprising one or more of a brackets information, a divisions information, a weight classes information, a gender information, or a skill level information.

5. The event coordination system of claim 1, with the event areas information comprising one or more of “not called yet” areas, holding areas, staging areas, or activity areas.

6. The event coordination system of claim 1, with the competition information comprising one or more of a number of activity areas, a number of weight classes, match unit time information, or total division time information.

7. The event coordination system of claim 1, with the competition information comprising time per round information, rest time between rounds information, break time between competitions information, or setup time per match information.

8. The event coordination system of claim 1, with the event schedule coordinating movement of participants into “not called yet” areas, movement of participants from “not called yet” areas to holding areas, movement of participants from holding areas to staging areas, and movement of participants from staging areas to activity areas.

9. The event coordination system of claim 1, with the event schedule coordinating movement of a particular event participant to a particular “not called yet” area, from the particular “not called yet” area to a particular holding area, from the particular holding area to a particular staging area, and from the particular staging area to a particular activity area.

10. The event coordination system of claim 1, further comprising using the event schedule to coordinate a plurality of event activities and a plurality of event participants of the competitive event.

11. The event coordination system of claim 1, further comprising communicating changes in the event schedule to one or more of event personnel, event participants, and event spectators.

12. The event coordination system of claim 1, further comprising communicating changes in the event schedule in real-time.

13. An event coordinator method for coordinating a competitive event, the method comprising:
obtaining event participant information for a plurality of event participants of the competitive event;
obtaining event areas information of the competitive event;
obtaining competition information of the competitive event; and
processing the event participant information with the event areas information and the competition information and generating the event schedule for coordinating the competitive event, wherein the event schedule coordinates the plurality of event participants over a plurality of event areas.

14. The method of claim 13, with the event participant information including a plurality of event participants.

15. The method of claim 13, with the event participant information comprising one or more of a participant name and participant identifier for each participant of the plurality of event participants.

16. The method of claim 13, with the event participant information comprising one or more of brackets information, divisions information, weight classes information, gender information, or skill level information.

17. The method of claim 13, with the event areas information comprising one or more of “not called yet” areas, holding areas, staging areas, or activity areas.

18. The method of claim 13, with the competition information comprising one or more of a number of activity areas, a number of weight classes, match unit time information, or total division time information.

19. The method of claim 13, with the competition information comprising time per round information, rest time between rounds information, break time between competitions information, or setup time per match information.

20. The method of claim 13, with the event schedule coordinating movement of participants into “not called yet” areas, movement of participants from “not called yet” areas to holding areas, movement of participants from holding areas to staging areas, and movement of participants from staging areas to activity areas.

21. The method of claim 13, with the event schedule coordinating movement of a particular event participant to a particular “not called yet” area, from the particular “not called yet” area to a particular holding area, from the particular holding area to a particular staging area, and from the particular staging area to a particular activity area.

22. The method of claim 13, further comprising using the event schedule to coordinate a plurality of event activities and a plurality of event participants of the competitive event.

23. The method of claim 13, further comprising communicating changes in the event schedule to one or more of event personnel, event participants, and event spectators.

24. The method of claim 13, further comprising communicating changes in the event schedule in real-time.
